(19) United States
(12) Patent Application Publication
(10) Pub. No.: US 2014/0064905 A1
(43) Pub. Date: Mar. 6, 2014

(54) Electroadhesive System for Capturing Objects

(71) Applicants: Harsha Prahlad, Cupertino, CA (US); Lyle Leveque, Mountain View, CA (US); Annjoe Wong-Foy, San Francisco, CA (US); Scott Williams, Burlingame, CA (US); Ronald E. Pelrine, Longmont, CO (US)

(72) Inventors: Harsha Prahlad, Cupertino, CA (US); Lyle Leveque, Mountain View, CA (US); Annjoe Wong-Foy, San Francisco, CA (US); Scott Williams, Burlingame, CA (US); Ronald E. Pelrine, Longmont, CO (US)

(73) Assignee: SRI INTERNATIONAL, Menlo Park, CA (US)

(21) Appl. No.: 13/994,008

(22) PCT Filed: Jan. 10, 2012
(86) PCT No.: PCT/US12/20810

§ 371 Date: Nov. 14, 2013

Related U.S. Application Data
(60) Provisional application No. 61/431,363, filed on Jan. 10, 2011.

(51) Int. Cl. H02N 13/00

(52) U.S. Cl. CPC H02N 13/00
USPC 414/751.1; 414/800

(57) ABSTRACT

A “sticky boom” system facilitates physical control of foreign objects, such as those in a zero-gravity environment. The electroadhesive system includes an electrostatic adhesion pad that electrostatically and detachably adheres to a separate foreign object, as well as a boom coupled to the pad. The pad includes electrode(s) adapted to produce an electrostatic force between the pad and the object that maintains the position of the pad relative to the object. The boom provides control for positioning the pad relative to the object and also for movement of the pad and object combination when they are electrostatically adhered together. A sensing component detects when the pad is adhered to the foreign object, and a control mechanism coupled to the boom allows for control of the pad and object at a remote distance. Multiple foreign objects can be adhered simultaneously. Control can include location and/or rotational movement or deceleration of objects.

### CROSS-REFERENCE TO RELATED APPLICATION

This application claims priority to U.S. Provisional Patent Application No. 61/431,363, filed Jan. 10, 2010, and entitled “AN ELECTROADHESIVE STICKY BOOM SYSTEM FOR CAPTURING OBJECTS IN SPACE,” which is incorporated by reference herein in its entirety and for all purposes.

### TECHNICAL FIELD

The present invention relates generally to electroadhesion and other electrostatic applications, and more particularly to the use of electroadhesion to retrieve or handle foreign objects.

### BACKGROUND

Solutions for rendezvous, docking and other object handling applications in outer space can present a number of challenges. In fact, existing spacecraft tend to utilize a substantial portion of their total mass simply for rendezvous and docking systems. This “dead mass” cannot be used for other cargo, and usually represents a complicated system that usually gets expended after a single mission. Further, many rendezvous and docking procedures involve close-in maneuvers or even “precision crashes” between large, high-inertia, extremely expensive objects. Such procedures typically takes place with the contact distance between objects being so small (e.g., less than 10 m) that all objects are at risk during the maneuver. Concerns over such issues results in a tendency to shy away from mission architectures that require multiple rendezvous and docking operations.

In light of such concerns, the National Aeronautics and Space Administration (“NASA”) has recently solicited rendezvous and docking solutions for autonomously collecting a sample canister for a Mars Sample Return mission. In particular, the Small Business Innovation Research & Technology Transfer Program Solicitation No. SBIR S5.04—Rendezvous and Docking Technologies for Orbiting Sample Capture—implicates such issues with respect to controlling and retrieving a canister in space. One of the potential solutions that NASA has been studying involves scooping the canister up into a funnel, closing a lid over the funnel to keep the canister from bouncing out, and then feeding the canister through a tunnel into the reentry capsules. Other alternative autonomous rendezvous and docking schemes use robot arms and the like.

Unfortunately, approaches such as the foregoing funnel-lid or robot arm based solutions tend to be overly complex and thus costly to implement. Such approaches can require the use of “capture target” mechanisms on the target vehicle or object, and can also require very precise orbit and velocity matching before rendezvous can proceed. As such, vehicles or other objects (e.g., space debris) that have not been prepared with capture target mechanisms in advance typically cannot be manipulated by such systems. These approaches can also require the use of multiple complex and precise components, the failure of any of which can cause havoc with the overall rendezvous and docking process.

Although various rendezvous and docking systems have generally worked well in the past, there is always a desire for improvement. In particular, what is desired are rendezvous and docking systems and procedures that are simpler, safer and cheaper, while still enabling rendezvous and docking with targets that have not been specifically designed for being captured.

### SUMMARY

It is an advantage of the present invention to provide improved rendezvous and docking systems and techniques. Such systems and techniques can generally present a lowered overall risk, allow for larger velocity or position misalignment between objects, keep pre-contact maneuvers for both vehicles or objects far enough away to eliminate the probability of accidental collisions, offload enough of the work from the “target vehicle” side to allow capture of uncooperative targets, and minimize the amount of vehicle mass dedicated to rendezvous and docking. This can be accomplished at least in part through applying a different approach that involves the use of electroadhesion and a boom coupled to the electrostatic components.

In various embodiments of the present invention, an electroadhesive system can include an electrostatic adhesion pad and a boom coupled at a first boom location to the electrostatic adhesion pad. The electrostatic adhesion pad can be configured to adhere electrostatically and detachably to a surface of a separate foreign object, and as such can include one or more electrodes adapted to produce collectively an electrostatic force between the pad and the object that is suitable to maintain a current position of the pad relative to the object. The boom can be adapted to provide control for positioning of the electrostatic adhesion pad with respect to the foreign object, and also for movement of the pad and object combination when the pad and object are electrostatically adhered together.

In various detailed embodiments, further system components can include a sensing component adapted to sense when the electrostatic adhesion pad is electrostatically adhered to the foreign object, as well as a control mechanism adapted to control the boom. Such a control mechanism can be coupled to the boom at a second boom location remote from the first boom location. In addition, the inertia of the control mechanism can be greater than the inertia of the boom, such that the greater distance between control mechanism and foreign object by way of the boom is a distinct advantage.

In various further embodiments, the electrostatic adhesion pad can include a deformable surface adapted for interfacing with the object surface such that at least a portion of the deformable surface moves closer to the object surface when the pad is adhering to the object. In addition, the electrostatic adhesion pad can comprise a flat or flexible component, and/or can include a plurality of separately controllable fingers. Further, the electrostatic adhesion pad can also be configured to adhere electrostatically and detachably to a surface of a second separate foreign object while the pad is simultaneously adhered to the original separate foreign object.

In further detailed embodiments, the boom can be elongated, and the first boom location can be at a distal end of the boom. Also, the boom can be extendable, retractable or both. In various embodiments, the foreign object can be a loose object within a zero-gravity environment, and the electroadhesive system can be adapted to manipulate the foreign object at a significant distance from any other object within the zero-gravity environment. Furthermore, the electroadhesive system can be adapted to manipulate the physical location of the foreign object, the rotational velocity of the foreign object, or both.

In still further embodiments, methods of operating an electroadhesive device are provided. Such methods can involve physically controlling a foreign object, and can include the use of an electroadhesive device or system such as that set forth above. Various method steps can include, for example, contacting an electrostatic adhesion pad to a surface of a separate foreign object, where the electrostatic adhesion pad includes one or more electrodes, applying an electrostatic adhesion voltage difference at one or more of the electrodes, electrostatically adhering the electrostatic adhesion pad to the object surface using an electrostatic attraction force provided by the electrostatic adhesion voltage difference, and changing the physical location of the foreign object, the rotational velocity of the foreign object, or both by controlling a boom coupled to the electrostatic adhesion pad while the pad and object are electrostatically adhered together.

Additional method steps can include increasing the surface area contact between the pad and the object surface by deforming a deformable surface on the electrostatic adhesion pad such that at least a portion of the deformable pad surface moves closer to the object surface after electrostatically adhering the electrostatic adhesion pad to the object surface, and also maintaining the electrostatic adhesion voltage difference while the deformable pad surface contacts the object surface of the substrate. Still further steps can include releasing the electrostatic adherence between the pad and the object by reducing or eliminating the electrostatic adhesion voltage difference, moving the electrostatic adhesion pad with respect to the foreign object while the electrostatic adhesion voltage is reduced or eliminated, and also reapplying an electrostatic adhesion voltage difference at one or more electrodes after the electrostatic adhesion pad has been moved to a different location of the foreign object.

In addition to, or alternatively to the foregoing, other method steps can also include sensing when the electrostatic adhesion pad is electrostatically adhered to the foreign object, and controlling the boom in response to sensing that the pad is electrostatically adhered to the foreign object. In addition, one or more of the recited steps can be performed with respect to one or more additional separate foreign objects. For example, the changing step can result in connecting the foreign object with a second separate foreign object.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive applications and systems for an electroadhesive sticky boom. These drawings in no way limit any changes in form and detail that may be made to the invention by one skilled in the art without departing from the spirit and scope of the invention.

FIG. 1A illustrates in side cross-sectional view an exemplary electroadhesive device.

FIG. 1B illustrates in side cross-sectional view the exemplary electroadhesive device of FIG. 1A adhered to a foreign object.

FIG. 1C illustrates in side cross-sectional close-up view an electric field formed in the foreign object of FIG. 1B as result of the voltage difference between electrodes in the adhered exemplary electroadhesive device.

FIG. 2A illustrates in side cross-sectional view an exemplary pair of electroadhesive gripping surfaces or devices having single electrodes thereon.

FIG. 2B illustrates in side cross-sectional view the exemplary pair of electroadhesive gripping surfaces or devices of FIG. 2A with voltage applied thereto.

FIG. 3A illustrates in top perspective view an exemplary electroadhesive gripping surface in the form of a sheet with electrodes patterned on top and bottom surfaces thereof.

FIG. 3B illustrates in top perspective view an alternative exemplary electroadhesive gripping surface in the form of a sheet with electrodes patterned on a single surface thereof.

FIG. 4A illustrates in side cross-sectional regular and close-up views a deformable electroadhesive device conforming to the shape of a rough surface according to one embodiment of the present invention.

FIG. 4B illustrates in partial side cross-sectional view a surface of a deformable electroadhesive device initially when the device is brought into contact with a surface of a structure according to one embodiment of the present invention.

FIG. 4C illustrates in partial side cross-sectional view the surface shape of electroadhesive device of FIG. 4B and wall surface after some deformation in the electroadhesive device due to the initial force of electrostatic attraction and compliance according to one embodiment of the present invention.

FIG. 5A illustrates in block diagram format an exemplary schematic of an electroadhesion in vacuum test arrangement according to one embodiment of the present invention.

FIGS. 5B and 5C illustrate close up photographs of electroadhesive pads showing aluminum traces and having such traces covered with polyimide tape for the vacuum test of FIG. 5A according to various embodiments of the present invention.

FIG. 6A illustrates a graph of the resulting peak clamping forces as measured on the force gage from the vacuum test of FIG. 5A according to one embodiment of the present invention.

FIG. 6B illustrates a graph that compares postulated modeling predictions against actual experimental data that was observed according to one embodiment of the present invention.

FIG. 7A illustrates in side perspective view an exemplary electroadhesive sticky boom system according to one embodiment of the present invention.

FIG. 7B illustrates in side perspective view the exemplary electroadhesive sticky boom system of FIG. 7A coupled to an exemplary controlling craft in outer space according to one embodiment of the present invention.

FIG. 8A illustrates in side perspective view the exemplary electroadhesive sticky boom system of FIG. 7A coupled to an alternative exemplary controlling craft and retrieving an exemplary target object in outer space according to one embodiment of the present invention.

FIG. 8B illustrates in side perspective view a pair of CubeSat modules having electroadhesive components adapted to facilitate docking according to one embodiment of the present invention.

FIG. 9 provides a flowchart of an exemplary method of operating an electroadhesive sticky boom according to one embodiment of the present invention

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The present invention relates in various embodiments to systems and methods involving the improved manipulation of objects. In some embodiments, various electroadhesive “sticky” boom systems and techniques are adapted to capture or otherwise manipulate objects. Such capture or manipulation can occur in outer space or other vacuum and/or no gravity environments, among other possible applications. In general, the invention can include the integration of electrostatic adhesion devices in combination with a deployable boom. In various detailed embodiments, the invention can involve the rendezvous and/or docking of objects in outer space. In particular implementations, the disclosed embodiments can be responsive to NASA SBIR S5.04—Rendezvous and Docking Technologies for Orbiting Sample Capture—which solicited rendezvous and docking solutions for autonomously collecting a sample canister for a Mars Sample Return mission.

The combination of a rendezvous boom with an electrostatic adhesion pad has several advantages both for this particular problem and in the context of a much wider commercial applicability. Various advantages can include, for example:
a smaller, simpler and lighter system (less than 1 kg for the boom, the electroadhesion pad, and the control electronics in some embodiments);
positive securing and retention of a sample object from initial contact without requiring explicit connection features integral to the object;
Combines several elements into a single subsystem, including initial capture and transfer to the reentry capsules, and can be small enough to be built directly into the reentry capsules in some embodiments;
Integrated mechanisms to detect successful acquisition of the target object (e.g., by measuring current flow changes);
Requires less RCS thrusters for rendezvous, decreasing risk of running out of propellant, contamination to the target spacecraft, and eliminating the need for precise RCS thrusters in some embodiments;
Increased stand-off distance between the capturing and target crafts or objects, reducing the odds of accidental collisions;
No need for specific grappling targets on the target spacecraft, and can dock with spacecraft or debris not designed for servicing;
Can grapple spacecraft that have lost control, either to reestablish control or to remove the debris, and can grab, release, and reposition as necessary;
Eliminates complex end effectors for such grappling systems, greatly simplifying the individual grappling booms.

While the various examples disclosed herein focus on particular aspects of specific electroadhesive applications, it will be understood that the various inventive principles and embodiments disclosed herein can be applied to other electrostatic applications and arrangements as well. For example, an electrolaminate application involving one or more electrostatically charged sheets can utilize the same types of general electrostatic principles for gripping and controlling foreign objects.

Furthermore, while the particular applications described herein are made with respect to spacecraft or other foreign objects in outer space, it will be readily appreciated that the combination electrostatic pad and boom combination can be used in a variety of other applications that are not necessarily in outer space, in vacuum or in zero gravity environments.

In providing various details for the contemplated embodiments, the following disclosure provides an initial discussion regarding electroadhesion, followed by a brief description of electrostatic properties seen within vacuum environments, and then various details regarding electroadhesive sticky booms and other electrostatic applications in similar contexts. A particular method of operating an electroadhesive sticky boom is then provided.

### Electroadhesion

As the term is used herein, “electroadhesion” refers to the mechanical coupling of two objects using electrostatic forces. Electroadhesion as described herein uses electrical control of these electrostatic forces to permit temporary and detachable attachment between two objects. This electrostatic adhesion holds two surfaces of these objects together or increases the traction or friction between two surfaces due to electrostatic forces created by an applied electrical field. Although electrostatic clamping has traditionally been limited to holding two flat, smooth and generally conductive surfaces separated by a highly insulating material together, the present invention involves electroadhesion devices and techniques that do not limit the material properties, curvatures, size or surface roughness of the objects subject to electroadhesive forces and handling. Furthermore, while the various examples and discussions provided herein typically involve electrostatically adhering a robot or other device to a foreign substrate, it will also be understood that many other types of electrostatic applications may also generally be implicated for use with the disclosed invention. For example, two components of the same device may be electrostatically adhered to each other, such as in an electrolaminate or other type of arrangement.

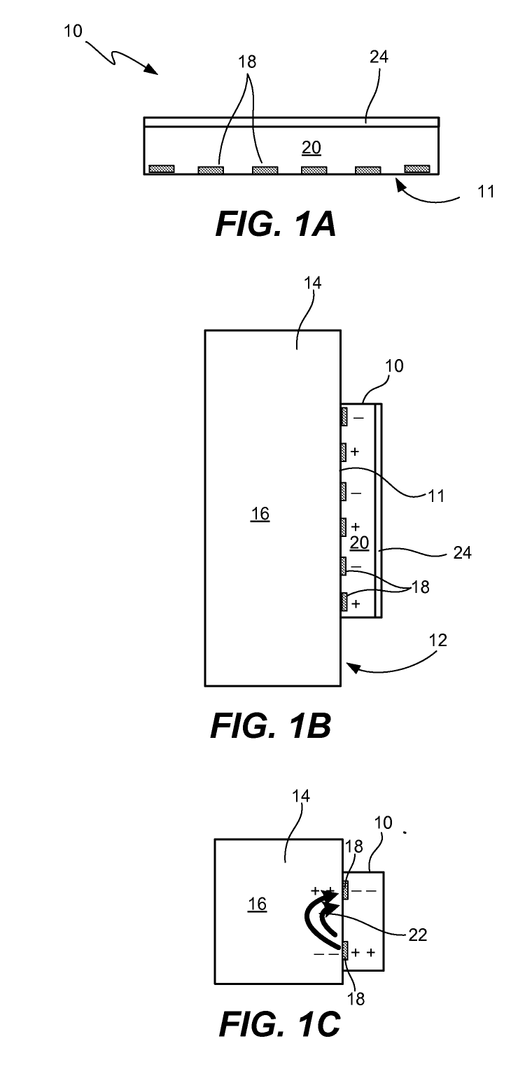

Turning first to FIG. 1A, an exemplary electroadhesive device according to one embodiment of the present invention is illustrated in elevated cross-sectional view. Electroadhesive device 10 includes one or more electrodes 18 located at or near an “electroadhesive gripping surface” 11 thereof, as well as an insulating material 20 between electrodes and a backing 24 or other supporting structural component. For purposes of illustration, electroadhesive device 10 is shown as having six electrodes in three pairs, although it will be readily appreciated that more or fewer electrodes can be used in a given electroadhesive device. Where only a single electrode is used in a given electroadhesive device, a complimentary electroadhesive device having at least one electrode of the opposite polarity is preferably used therewith. With respect to size, electroadhesive device 10 is substantially scale invariant. That is, electroadhesive device sizes may range from less than 1 square centimeter to greater than several meters in surface area. Even larger and smaller surface areas also possible, and may be sized to the needs of a given application.

FIG. 1B depicts in elevated cross-sectional view the exemplary electroadhesive device 10 of FIG. 1A adhered to a foreign object 14 according to one embodiment of the present invention. Foreign object 14 includes surface 12 and inner material 16. Electroadhesive gripping surface 11 of electroadhesive device 10 is placed against or nearby surface 12 of foreign object 14. An electrostatic adhesion voltage is then applied via electrodes 18 using external control electronics (not shown) in electrical communication with the electrodes 18. As shown in FIG. 1B, the electrostatic adhesion voltage uses alternating positive and negative charges on neighboring electrodes 18. As result of the voltage difference between electrodes 18, one or more electroadhesive forces are generated, which electroadhesive forces act to hold the electroadhesive device 10 and foreign object 14 against each other. Due to the nature of the forces being applied, it will be readily appreciated that actual contact between electroadhesive device 10 and foreign object 14 is not necessary. For example, a piece of paper, thin film, or other material or substrate may be placed between electroadhesive device 10 and foreign object 14. Furthermore, although the term “contact” is used herein to denote the interaction between an electroadhesive device and a foreign object, it will be understood that actual direct surface to surface contact is not always required, such that one or more thin objects such as an insulator, can be disposed between an electroadhesive gripping surface and the foreign object. In some embodiments such an insulator between the gripping surface and foreign object can be a part of the device, while in others it can be a separate item or device.

FIG. 1C illustrates in elevated cross-sectional close-up view an electric field formed in the foreign object of FIG. 1B as result of the voltage difference between electrodes in the adhered exemplary electroadhesive device 10. While the electroadhesive device 10 is placed against foreign object 14 and an electrostatic adhesion voltage is applied, an electric field 22 forms in the inner material 16 of the foreign object 14. The electric field 22 locally polarizes inner material 16 or induces direct charges on material 16 locally opposite to the charge on the electrodes 18 of the device, and thus causes electrostatic adhesion between the electrodes 18 (and overall device 10) and the induced charges on the foreign object 14. The induced charges may be the result of a dielectric polarization or from weakly conductive materials and electrostatic induction of charge. In the event that the inner material 16 is a strong conductor, such as copper for example, the induced charges may completely cancel the electric field 22. In this case the internal electric field 22 is zero, but the induced charges nonetheless still form and provide electrostatic force to the device 10. Again, an insulator may also be provided between the device 10 and foreign object 14 in instances where material 16 is copper or another strong conductor.

Thus, the electrostatic adhesion voltage provides an overall electrostatic force, between the electroadhesive device 10 and inner material 16 beneath surface 12 of foreign object 14, which electrostatic force maintains the current position of the electroadhesive device relative to the surface of the foreign object. The overall electrostatic force may be sufficient to overcome the gravitational pull on the foreign object 14, such that the electroadhesive device 10 may be used to hold the foreign object aloft. In various embodiments, a plurality of electroadhesive devices may be placed against foreign object 14, such that additional electrostatic forces against the object can be provided. The combination of electrostatic forces may be sufficient to lift, move, pick and place, or otherwise handle the foreign object. Electroadhesive device 10 may also be attached to other structures and hold these additional structures aloft, or it may be used on sloped or slippery surfaces to increase normal friction forces

Removal of the electrostatic adhesion voltages from electrodes 18 ceases the electrostatic adhesion force between electroadhesive device 10 and the surface 12 of foreign object 14. Thus, when there is no electrostatic adhesion voltage between electrodes 18, electroadhesive device 10 can move more readily relative to surface 12. This condition allows the electroadhesive device 10 to move before and after an electrostatic adhesion voltage is applied. Well controlled electrical activation and de-activation enables fast adhesion and detachment, such as response times less than about 50 milliseconds, for example, while consuming relatively small amounts of power. Larger release times may also be valuable in many applications.

Electroadhesive device 10 includes electrodes 18 on an outside surface 11 of an insulating material 20. This embodiment is well suited for controlled attachment to insulating and weakly conductive inner materials 14 of various foreign objects 16. Other electroadhesive device 10 relationships between electrodes 18 and insulating materials 20 are also contemplated and suitable for use with a broader range of materials, including conductive materials. For example, a thin electrically insulating material (not shown) can be located on the surfaces of the electrodes where surface 12 is on a metallic object. As will be readily appreciated, a shorter distance between surfaces 11 and 12 results in a stronger electroadhesive force between the objects. Accordingly, a deformable surface 11 adapted to at least partially conform to the surface 12 of the foreign object 14 can be used.

As the term is used herein, an electrostatic adhesion voltage refers to a voltage that produces a suitable electrostatic force to couple electroadhesive device 10 to a foreign object 14. The minimum voltage needed for electroadhesive device 10 will vary with a number of factors, such as: the size of electroadhesive device 10, the material conductivity and spacing of electrodes 18, the insulating material 20, the foreign object material 16, the presence of any disturbances to electroadhesion such as dust, other particulates or moisture, the weight of any objects being supported by the electroadhesive force, compliance of the electroadhesive device, the dielectric and resistivity properties of the foreign object, and the relevant gaps between electrodes and foreign object surface. In one embodiment, the electrostatic adhesion voltage includes a differential voltage between the electrodes 18 that is between about 500 volts and about 15 kilovolts. Even lower voltages may be used in micro applications. In one embodiment, the differential voltage is between about 2 kilovolts and about 5 kilovolts. Voltage for one electrode can be zero. Alternating positive and negative charges may also be applied to adjacent electrodes 18. The voltage on a single electrode may be varied in time, and in particular may be alternated between positive and negative charge so as to not develop substantial long-term charging of the foreign object. The resultant clamping forces will vary with the specifics of a particular electroadhesive device 10, the material it adheres to, any particulate disturbances, surface roughness, and so forth. In general, electroadhesion as described herein provides a wide range of clamping pressures, generally defined as the attractive force applied by the electroadhesive device divided by the area thereof in contact with the foreign object

The actual electroadhesion forces and pressure will vary with design and a number of factors. In one embodiment, electroadhesive device 10 provides electroadhesive attraction pressures between about 0.7 kPa (about 0.1 psi) and about 70 kPa (about 10 psi), although other amounts and ranges are certainly possible. The amount of force needed for a particular application may be readily achieved by varying the area of the contacting surfaces, varying the applied voltage, and/or varying the distance between the electrodes and foreign object surface, although other relevant factors may also be manipulated as desired.

Although electroadhesive device 10 having electroadhesive gripping surface 11 of FIG. 1A is shown as having six electrodes 18, it will be understood that a given electroadhesive device or gripping surface can have just a single electrode. Furthermore, it will be readily appreciated that a given electroadhesive device can have a plurality of different electroadhesive gripping surfaces, with each separate electroadhesive gripping surface having at least one electrode and being adapted to be placed against or in close proximity to the foreign object to be gripped. Although the terms electroadhesive device, electroadhesive gripping unit and electroadhesive gripping surface are all used herein to designate electroadhesive components of interest, it will be understood that these various terms can be used interchangeably in various contexts. In particular, while a given electroadhesive device might comprise numerous distinct “gripping surfaces,” these different gripping surfaces might themselves also be considered separate “devices” or alternatively “end effectors.”

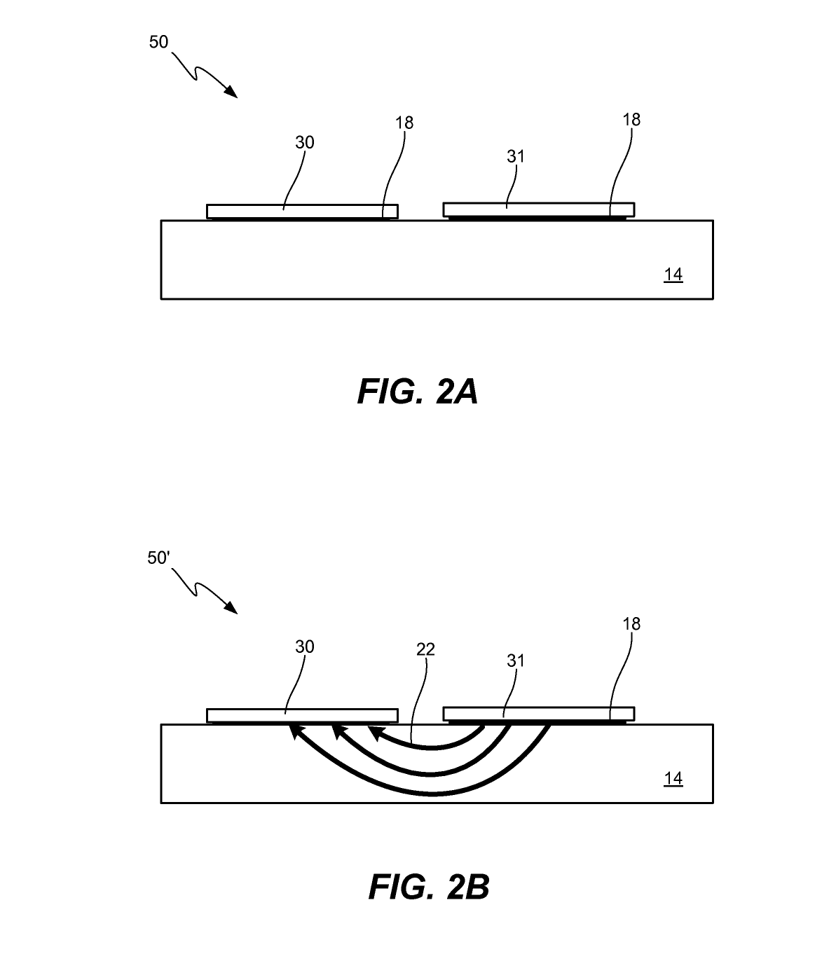

Referring to FIGS. 2A and 2B, an exemplary pair of electroadhesive devices or gripping surfaces having single electrodes thereon is shown in side cross-sectional view. FIG. 2A depicts electroadhesive gripping system 50 having electroadhesive devices or gripping surfaces 30, 31 that are in contact with the surface of a foreign object 16, while FIG. 2B depicts activated electroadhesive gripping system 50′ with the devices or gripping surfaces having voltage applied thereto. Electroadhesive gripping system 50 includes two electroadhesive devices or gripping surfaces 30, 31 that directly contact the foreign object 14. Each electroadhesive device or gripping surface 30, 31 has a single electrode 18 coupled thereto. In such cases, the electroadhesive gripping system can be designed to use the foreign object as an insulation material. When voltage is applied, an electric field 22 forms within foreign object 14, and an electrostatic force between the electroadhesive devices or gripping surfaces 30, 31 and the foreign object is created. Various embodiments that include numerous of these single electrode electroadhesive devices can be used, as will be readily appreciated.

In some embodiments, an electroadhesive gripping surface can take the form of a flat panel or sheet having a plurality of electrodes thereon. In other embodiments, the gripping surface can take a fixed shape that is matched to the geometry of the foreign object most commonly lifted or handled. For example, a curved geometry can be used to match the geometry of a cylindrical paint can or soda can. The electrodes may be enhanced by various means, such as by being patterned on an adhesive device surface to improve electroadhesive performance, or by making them using soft or flexible materials to increase compliance and thus conformance to irregular surfaces on foreign objects.

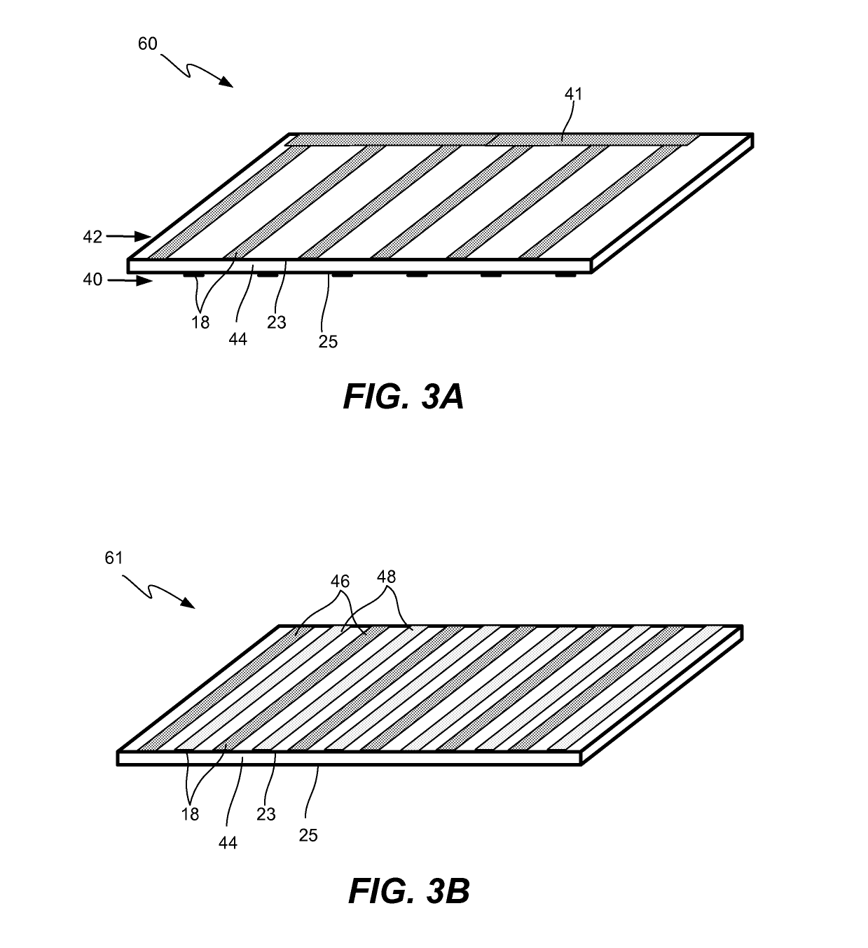

Continuing with FIGS. 3A and 3B, two examples of electroadhesive gripping surfaces in the form of flat panels or sheets with electrodes patterned on surfaces thereof are shown in top perspective view. FIG. 3A shows electroadhesive gripping surface 60 in the form of a sheet or flat panel with electrodes 18 patterned on top and bottom surfaces thereof. Top and bottom electrodes sets 40 and 42 are interdigitated on opposite sides of an insulating layer 44. In some cases, insulating layer 44 can be formed of a stiff or rigid material. In some cases, the electrodes as well as the insulating layer 44 may be compliant and composed of a polymer, such as an acrylic elastomer, to increase compliance. In one preferred embodiment the modulus of the polymer is below about 10 MPa and in another preferred embodiment it is more specifically below about 1 MPa. Various types of compliant electrodes suitable for use with the present invention are generally known, and examples are described in commonly owned U.S. Pat. No. 7,034,432, which is incorporated by reference herein in its entirety and for all purposes.

Electrode set 42 is disposed on a top surface 23 of insulating layer 44, and includes an array of linear patterned electrodes 18. A common electrode 41 electrically couples electrodes 18 in set 42 and permits electrical communication with all the electrodes 18 in set 42 using a single input lead to common electrode 41. Electrode set 40 is disposed on a bottom surface 25 of insulating layer 44, and includes a second array of linear patterned electrodes 18 that is laterally displaced from electrodes 18 on the top surface. Bottom electrode set 40 may also include a common electrode (not shown). Electrodes can be patterned on opposite sides of an insulating layer 44 to increase the ability of the electroadhesive end effector 60 to withstand higher voltage differences without being limited by breakdown in the air gap between the electrodes, as will be readily appreciated.

Alternatively, electrodes may also be patterned on the same surface of the insulating layer, such as that which is shown in FIG. 3B. As shown, electroadhesive gripping surface 61 comprises a sheet or flat panel with electrodes 18 patterned only on one surface thereof. Electroadhesive gripping surface 61 can be substantially similar to electroadhesive gripping surface 60 of FIG. 3A, except that electrodes sets 46 and 48 are interdigitated on the same surface 23 of a compliant insulating layer 44. No electrodes are located on the bottom surface 25 of insulating layer 44. This particular embodiment decreases the distance between the positive electrodes 18 in set 46 and negative electrodes 18 in set 48, and allows the placement of both sets of electrodes on the same surface of electroadhesive gripping surface 61. Functionally, this eliminates the spacing between the electrodes sets 46 and 48 due to insulating layer 44, as in embodiment 60. It also eliminates the gap between one set of electrodes (previously on bottom surface 25) and the foreign object surface when the top surface 23 adheres to the foreign object surface. Although either embodiment 60 or 61 can be used, these changes in the latter embodiment 61 do increase the electroadhesive forces between electroadhesive gripping surface 61 and the subject foreign object to be handled.

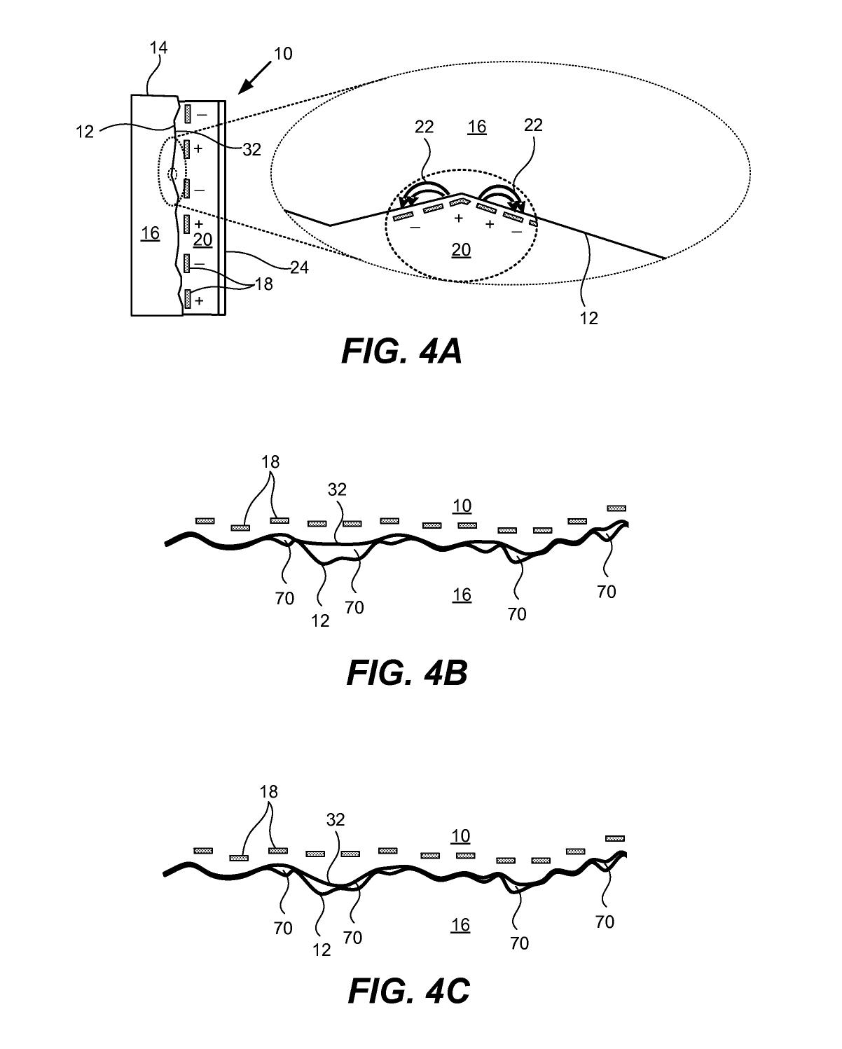

Another distinguishing feature of electroadhesive devices described herein is the option to use deformable surfaces and materials in electroadhesive device 10 as shown in FIGS. 4A-4C. In one embodiment, one or more portions of electroadhesive device 10 are deformable. In a specific embodiment, this includes surface 32 on device 10. In another embodiment, insulating material 20 between electrodes 18 is deformable. Electroadhesive device 10 may achieve the ability to deform using material compliance (e.g., a soft material as insulating material 20) or structural design (e.g., see cilia or hair-like structures). In a specific embodiment, insulating material 20 includes a bendable but not substantially elastically extendable material (for example, a thin layer of mylar). In another embodiment insulating material 20 is a soft polymer with modulus less than about 10 MPa and more specifically less than about 1 MPa.

Electrodes 18 may also be compliant. Compliance for insulating material 20 and electrodes 18 may be used in any of the electroadhesive device arrangements 10 described above. Compliance in electroadhesive device 10 permits an adhering surface 32 of device 10 to conform to surface 12 features of the object it attaches to. FIG. 4A shows a compliant electroadhesive device 10 conforming to the shape of a rough surface 12 in accordance with a specific embodiment of the present invention.

Adhering surface 32 is defined as the surface of an electroadhesive device that contacts the substrate surface 12 being adhered to. The adhering surface 32 may or may not include electrodes. In one embodiment, adhering surface 32 includes a thin and compliant protective layer that is added to protect electrodes that would otherwise be exposed. In another embodiment, adhering surface 32 includes a material that avoids retaining debris stuck thereto (e.g., when electrostatic forces have been removed). Alternatively, adhering surface 32 may include a sticky or adhesive material to help adhesion to a wall surface or a high friction material to better prevent sliding for a given normal force.

Compliance in electroadhesive device 10 often improves adherence. When both electrodes 18 and insulating material 20 are able to deform, the adhering surface 32 may conform to the micro- and macro-contours of a rough surface 12, both initially and dynamically after initial charge has been applied. This dynamic compliance is described in further detail with respect to FIG. 4B. This surface electroadhesive device 10 compliance enables electrodes 18 get closer to surface 12, which increases the overall clamping force provided by device 10. In some cases, electrostatic forces may drop off with distance (between electrodes and the wall surface) squared. The compliance in electroadhesive device 10, however, permits device 10 to establish, dynamically improve and maintain intimate contact with surface 14, thereby increasing the applied holding force applied by the electrodes 18. The added compliance can also provide greater mechanical interlocking on a micro scale between surfaces 12 and 32 to increase the effective friction and inhibit sliding.

The compliance permits electroadhesive device 10 to conform to the wall surface 12 both initially—and dynamically after electrical energy has been applied. This dynamic method of improving electroadhesion is shown in FIGS. 4B and 4C in accordance with another embodiment of the present invention. FIG. 4B shows a surface 32 of electroadhesive device 10 initially when the device 10 is brought into contact with surface 12 of a structure with material 16. Surface 12 may include roughness and non-uniformities on a macro, or visible, level (for example, the roughness in concrete can easily be seen) and a microscopic level (most materials).

At some time when the two are in contact as shown in FIG. 4B, electroadhesive electrical energy is applied to electrodes 18. This creates a force of attraction between electrodes 18 and wall surface 12. However, initially, as a practical matter for most rough surfaces, as can be seen in FIG. 4B, numerous gaps 70 are present between device surface 32 and wall surface 12. The number and size of these gaps 70 affects electroadhesive clamping pressures. For example, at macro scales electrostatic clamping is inversely proportional to the square of the gap between the substrate 16 and the charged electrodes 18. Also, a higher number of electrode sites allows device surface 32 to conform to more local surface roughness and thus improve overall adhesion. At micro scales, though, the increase in clamping pressures when the gap is reduced is even more dramatic. This increase is due to Paschen's law, which states that the breakdown strength of air increases dramatically across small gaps. Higher breakdown strengths and smaller gaps imply much higher electric fields and therefore much higher clamping pressures. Clamping pressures may be increased, and electroadhesion improved, by using a compliant surface 32 of electroadhesive device 10, or an electroadhesion mechanism that conforms to the surface roughness.

When the force of attraction overcomes the compliance in electroadhesive device 10, these compliant portions deform and portions of surface 32 move closer to surface 12. This deformation increases the contact area between electroadhesive device 10 and wall surface 12, increases electroadhesion clamping pressures, and provides for stronger electroadhesion between device 10 and wall 14. FIG. 4C shows the surface shape of electroadhesive device 10 and wall surface 12 after some deformation in electroadhesive device 10 due to the initial force of electrostatic attraction and compliance. Many of the gaps 70 have become smaller.

This adaptive shaping may continue. As the device surface 32 and wall surface 12 get closer, the reducing distance therebetween in many locations further increases electroadhesion forces, which causes many portions of electroadhesive device 10 to further deform, thus bringing even more portions of device surface 32 even closer to wall surface 12. Again, this increases the contact area, increases clamping pressures, and provides for stronger electroadhesion between device 10 and wall 14. The electroadhesive device 10 reaches a steady state in conformity when compliance in the device prevents further deformation and device surface 32 stops deforming.

In some embodiments, electroadhesive device 10 includes porosity in one or more of electrodes 18, insulating material 20 and backing 24. Pockets of air may be trapped between surface 12 and surface 32; these air pockets may reduce adaptive shaping. Tiny holes or porous materials for insulator 20, backing 24, and/or electrodes 18 allows trapped air to escape during dynamic deformation. Thus, electroadhesive device 10 is well suited for use with rough surfaces, or surfaces with macroscopic curvature or complex shape. In one embodiment, surface 12 includes roughness greater than about 100 microns. In a specific embodiment, surface 12 includes roughness greater than about 3 millimeters.

An optional backing structure 24, such as shown in FIGS. 1A and 4A, can attach to insulating material 20 and include a rigid or non-extensible material. Backing layer or structure 24 can provide structural support for the compliant electroadhesive device. Backing layer 24 also permits external mechanical coupling to the electroadhesive device to permit the device to be used in larger devices, such as wall-crawling robots and other devices and applications described below.

With some electroadhesive devices 10, softer materials may warp and deform too much under mechanical load, leading to suboptimal clamping. To mitigate these effects, electroadhesive device 10 may include a graded set of layers or materials, where one material has a low stiffness or modulus for coupling to the wall surface and a second material, attached to a first passive layer, which has a thicker and/or stiffer material. Backing structure 24 may attach to the second material stiffer material. In a specific embodiment, electroadhesive device 10 included an acrylic elastomer of thickness approximately 50 microns as the softer layer and a thicker acrylic elastomer of thickness 1000 microns as the second support layer. Other thicknesses may be used.

The time it takes for the changes of FIGS. 4B and 4C may vary with the electroadhesive device 10 materials, electroadhesive device 10 design, the applied control signal, and magnitude of electroadhesion forces. The dynamic changes can be visually seen in some electroadhesive devices. In one embodiment, the time it takes for device surface 32 to stop deforming can be between about 0.01 seconds and about 10 seconds. In other cases, the conformity ceasing time is between about 0.5 second and about 2 seconds.

In some embodiments, electroadhesion as described herein permits fast clamping and unclamping times and may be considered almost instantaneous. In one embodiment, clamping or unclamping may be achieved in less than about 50 milliseconds. In a specific embodiment, clamping or unclamping may be achieved in less than about 10 milliseconds. The speed may be increased by several means. If the electrodes are configured with a narrower line width and closer spacing, then speed is increased using conductive or weakly conductive substrates because the time needed for charge to flow to establish the electroadhesive forces is reduced (basically the

“RC” time constant of the distributed resistance-capacitance circuit including both electroadhesive device and substrate is reduced). Using softer, lighter, more adaptable materials in device 10 will also increase speed. It is also possible to use higher voltage to establish a given level of electroadhesive forces more quickly, and one can also increase speed by overdriving the voltage temporarily to establish charge distributions and adaptations quickly. To increase unclamping speeds, a driving voltage that effectively reverses polarities of electrodes 18 at a constant rate may be employed. Such a voltage prevents charge from building up in substrate material 16 and thus allows faster unclamping. Alternatively, a moderately conductive material 20 can be used between the electrodes 18 to provide faster discharge times at the expense of some additional driving power required.

As the term is used herein, an electrostatic adhesion voltage refers to a voltage that produces a suitable electrostatic force to couple electroadhesive device 10 to a wall, substrate or other object. The minimum voltage needed for electroadhesive device 10 will vary with a number of factors, such as: the size of electroadhesive device 10, the material conductivity and spacing of electrodes 18, the insulating material 20, the wall or object material 16, the presence of any disturbances to electroadhesion such as dust, other particulates or moisture, the weight of any structures mechanically coupled to electroadhesive device 10, compliance of the electroadhesive device, the dielectric and resistivity properties of the substrate, and the relevant gaps between electrodes and substrate. In one embodiment, the electrostatic adhesion voltage includes a differential voltage between the electrodes 18 that is between about 500 volts and about 10 kilovolts. In a specific embodiment, the differential voltage is between about 2 kilovolts and about 5 kilovolts. Voltage for one electrode can be zero. Alternating positive and negative charges may also be applied to adjacent electrodes 18.

Various additional details and embodiments regarding electroadhesion, electrolaminates, electroactive polymers, wall-crawling robots, and applications thereof can be found at, for example, U.S. Pat. Nos. 6,586,859; 6,911,764; 6,376,971; 7,411,332; 7,551,419; 7,554,787; and 7,773,363; as well as International Patent Application No. PCT/US2011/029101; and also U.S. patent application Ser. No. 12/762,260, each of the foregoing of which is incorporated by reference herein.

### Electroadhesive Applications Under Vacuum

Given that at least some of the contemplated embodiments involve use in outer space or a similar vacuum and/or zero gravity type environment, it may be worth considering the implications of such environments on electrostatic applications. In particular, a comprehensive validation of electroadhesion in such environments should consider testing in vacuum, electron bombardment, ultraviolet radiation, temperature extremes and/or plasma environments, among other potential considerations. Plasma in particular may pose some challenges to electroadhesion and other electrostatic applications, since plasma can be weakly conductive and thus potentially neutralize charges and/or require greater power consumption.

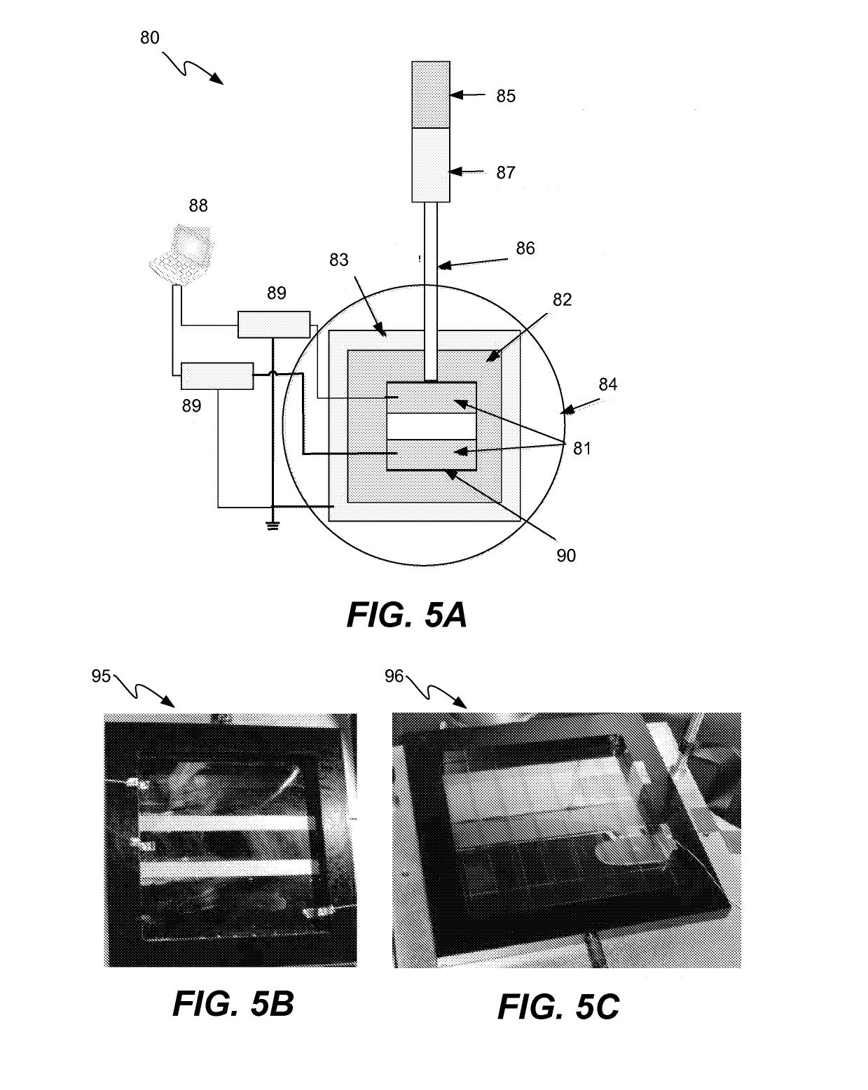

As a first step toward validating electrostatic applications in such environments of interest, testing was conducted under a high vacuum using electroadhesion clamps comprised of materials having properties that are already in use in outer space environments. Turning next to FIG. 5A, an exemplary schematic of an electroadhesion in vacuum test arrangement is provided in block diagram format. As shown, a plurality of electrodes 81 mounted on a test plate 82 that is in turn mounted on an aluminum base plate 83 are included within a vacuum defined by a vacuum chamber wall 84. Pull motor 85 can be adapted to provide a vacuum thereto by way of bellows or mechanical feed through 86, and as measured by a force gauge 87. Labview 88 can be adapted to control the power supply (e.g., voltage, current, wave form) from power supplies 89 to the electrodes 81, which are part of a test clamp 90 within the vacuum chamber.

As shown, the actual test apparatus consisted of a small electroadhesion pad (10 cm×10 cm active window) clamped to a substrate plate inside of a vacuum chamber. Clamping forces were measured by pulling on the pad through a vacuum rated mechanical bellow using a linear actuator located outside the vacuum chamber. Universal joints at the actuator end and the pad end were mounted to allow misalignment between the electroadhesion pad and the pulling linear actuator. A Mark-10 force gage (50 lb maximum force, or approximately 222 N) was mounted in-line with the linear actuator to measure pull force. The differences between the forces when no voltage was supplied to the EA clamp, and those when voltage was supplied to the clamp using an HV amplifier, were measured and tabulated.

The electroadhesion pads for this test were made out of a Delrin® frame attached to an Aluminum-coated Mylar, such as a polyethylene terephthalate (“PET”) sheet made by Tap Plastics. This sheet had a total thickness of 25 micrometers and an aluminum coating, which can be patterned by using a tape-based lift-off process. The electrode pattern used had three broad regions, which included a narrow central band connected to ground and two broader traces on either side. These broader traces were each powered using a Trek Model 510D high voltage amplifier, using a bipolar AC waveform (+/−2 kV, 1 Hz square wave) to prevent permanent charging of the Mylar insulator. The two broad traces were activated by waveforms which were 90 degrees out of phase, so as to prevent them from simultaneously going through the 0-point during polarity reversal of the waveform.

In order to prevent the electroadhesion pad from arcing or eroding the electrodes due to self-generated plasma, the back-side of the clamp was covered with a high temperature polyimide (Kapton®) tape (Digikey part # 47029). Forces were measured on an aluminum plate acting as a substrate. Forces were also measured by insulating the aluminum plate using polyimide film of various thicknesses, so as to simulate an insulated metal material. FIGS. 5B and 5C provide close up photographs from this test process of an electroadhesive pad showing aluminum traces 95, as well as an electroadhesive pad with traces that were covered with the Kapton® tape 96.

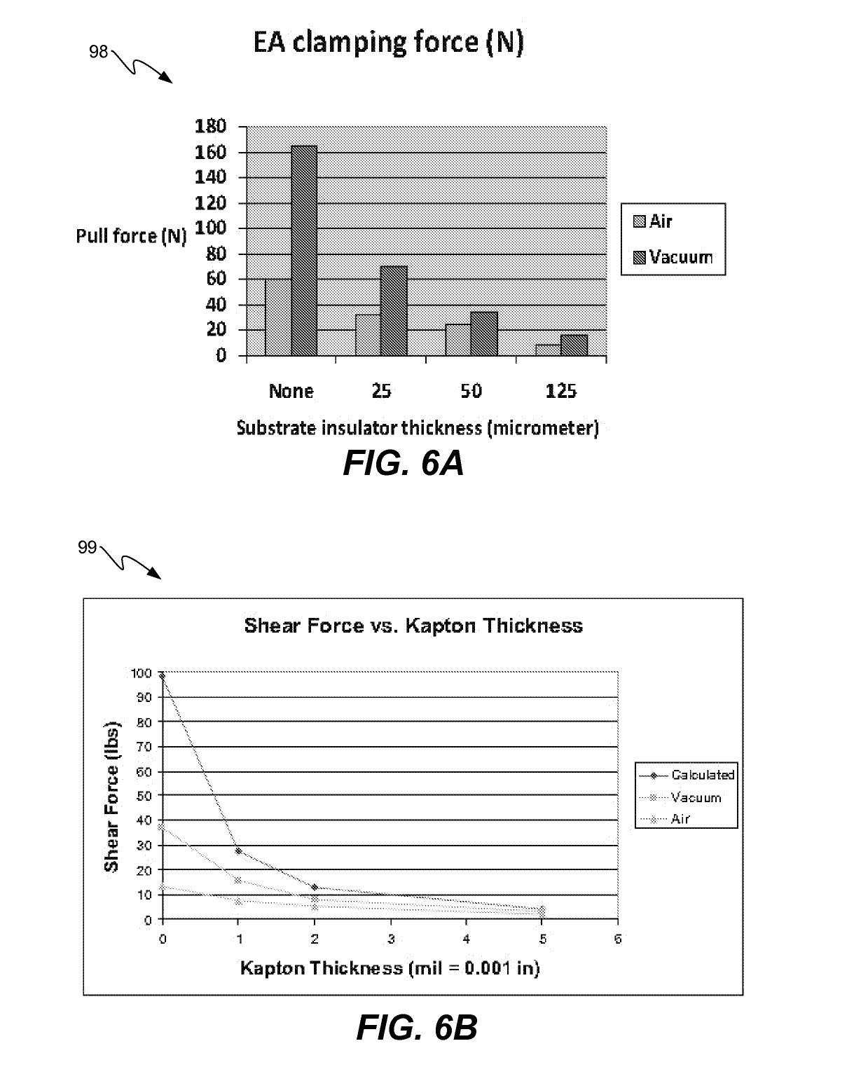

FIG. 6A provides a graph that shows the resulting peak clamping forces as measured on the force gage. It can be seen from graph 98 that the clamping forces in vacuum are higher in vacuum than in air. This can be attributed to the fact that localized breakdown of the air layer trapped between the electroadhesive pad and substrate limits the practical clamping force achievable in air.

Such a strong influence of trapped air gaps on clamping forces was further confirmed using Finite Element Modeling (“FEM”). The FEM was conducted using Matlab® scripting of the FE software COMSOL® in a Linux-based setup. A parametric simulation of eleven design parameters was conducted, including variables for electroadhesive pad insulation material thickness, substrate insulation thickness, conductivity of medium (to simulate plasma environments) and material properties (conductivities) for both substrate and spacer (insulator), among other factors.

Representative results from this modeling found that when the gap between the electroadhesive pad and substrate is zero (i.e., the pad is in intimate contact with the substrate), then the conductivity of the medium does not affect the clamping force. When there is a non-zero gap, however, then the conductivity does influence the clamping force, with greater conductivities reducing the clamping force. The exact nature of space plasma is much more complicated, and the gap between the pad and substrate is likely to be close to zero in some places, but non-zero in others.

Apart from the above drop with conductivity, having a small air gap in some places between the EA pad and substrate could be beneficial in some instances. For example, the gap can only exist in some places, since contact is necessary to achieve frictional load transfer between substrate and pad. In general, more resistive substrate materials will tend to exhibit less clamping force than more conductive substrate materials.

FIG. 6B provides a graph that compares these foregoing modeling predictions against actual experimental data. It can be seen from graph 99 that the overly simplified model did not account for effects of the partial breakdown of air between the substrate and electroadhesive pad. As such, the magnitude of the forces predicted was exaggerated. Overall, however, various trends of the experimental tests were qualitatively predicted by the model. This modeling therefore serves as a valuable tool in the optimal design of electroadhesive pads for various applications.

### Electroadhesive Sticky Boom

Again, various particular embodiments of the present disclosure are directed toward an electroadhesive “sticky” boom system that is adapted to capture or otherwise manipulate objects, such as in outer space or other vacuum and/or zero gravity environments, among other possible applications. In general, the disclosed embodiments can include the combination of electrostatic adhesion devices with a boom. Such a boom can be deployable in an extendable and/or retractable manner. As noted above, various embodiments can involve the rendezvous and/or docking of objects in outer space.

In general, an electrostatic adhesion pad or electroadhesion pad (“EA pad”) can be placed at the end of an extensible and/or retractable boom to enable easier rendezvous and docking, as well as capture of uncooperative satellites or other objects in outer space. The EA pad is preferably able to “stick” (i.e., electrostatically adhere) to many or all spacecraft or foreign object surfaces without requiring any sort of target mechanism on the vehicle or object being captured. In addition, the boom provides the benefit of a low-inertia connection at a distance between the controlling device and captured object. Such a “connection at a distance” serves to increase rendezvous and docking safety while also simplifying the various problems that arise as the objects near each other just before docking. That is, such a sticky boom system allows the general “last several meters” problem of a rendezvous or docking procedure to be solved non-propulsively. This can be done by using precision electric motors to guide the device to the target at a distance that is remote to the motors and controlling item, which significantly reduces the risk of an accidental collision between the controlling device and foreign object being captured.

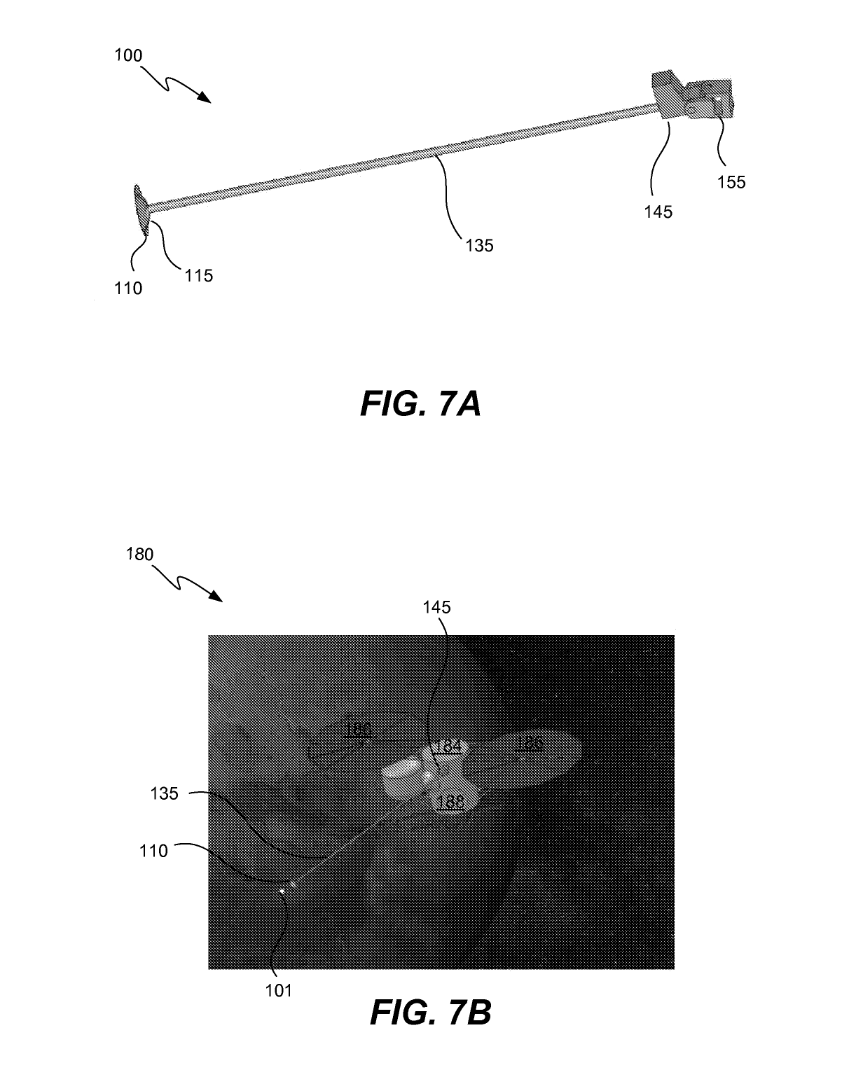

Turning next to FIG. 7A, an exemplary electroadhesive sticky boom system according to one embodiment of the present invention is shown in side perspective view. Electroadhesive sticky boom system 100 generally includes two major components, with those being the electrostatic adhesion pad 110 and the boom 135 and its associated components. One or more fingers 115 or other mechanical features or components can characterize the electroadhesion pad 110, which can be located at or near one distal end of the boom 135. At or near an opposing distal end of the boom 135 can various controls and/or a boom deployment can 145, as well as a gimbal mount 155 or other suitable mounting to facilitate varied control of the boom. The various controls or deployment mechanism 145 can include or be coupled to a remote motor that advantageously guides the EA pad 110 at the end of the boom 135, and all at a significant distance away from the motor, other equipment and overall capturing device.

In various detailed embodiments, the EA pad can be configured to be inherently capable of providing contact and proximity detection. As will be readily appreciated, the capacitance between electrodes will change in a detectable manner as a foreign surface approaches, such that provisions can be made to detect whether a surface is in or near contact. Such provisions can be by way of one or more capacitive contact sensors that detect when surface contact is made or an electrostatic clamp is present, or by measuring the leakage current that is inherent to such a clamp.

Such a feature can be important for various rendezvous or docking tasks, and can be used to provide feedback as to the existence and strength of a clamp to an operator or other overall controlling device. In the event that multiple EA pads are used, then multiple sensors can be used to provide varying states of on or off clamping.

In various embodiments, the EA pad or pads can take many possible forms. Such an EA pad could be a flat or flexible pad that is coupled to the boom using some form of compliant mechanism. Alternatively, the EA pad or pads could be combined with a more traditional electromechanical end effector. The EA pad could also use multiple petals or fingers, which may have artificial muscles on one or more sides to allow them to curl, uncurl or otherwise actuate. Further, the EA pad could comprise a multi-faceted ball-like object having multiple flat or curved pads on multiple sides. Such an arrangement can allow more freedom to maneuver the boom into final contact with the target surface in some embodiments.

Another advantage of the disclosed electroadhesive sticky boom is that a more ready and easy connection between two objects is enabled, even where the two objects have a modest relative velocity error between them. This can be accomplished by first making contact with the EA pad at the end of the boom, and then extending or retracting the boom at an appropriate rate that provides a steady, gradual deceleration (or acceleration as may be appropriate) until the two object velocity vectors have matched.

Continuing in the same general manner, the sticky boom can be used reduce spin gradually on an undesirably tumbling target, even one of substantial size. This can be accomplished by “grabbing” the object with the EA pad activated at a point on the object that is away from the spin axis. Some amount of deceleration can then be subjected at that point (i.e., providing a counter-torque on the body) as the object spins or rotates into the direction of the boom. The EA pad can then be turned off, the pad released, and the boom pulled back to reposition the pad. Any number of propulsive maneuvers on the boom, controlling device or host spacecraft can also be performed to null out relative motion, if needed or helpful. The entire process can then be repeated as many times as desired after the EA pad is relocated and adhered to the surface until the target object has had its spin reduced or eliminated.

In various embodiments, the boom can be any of a number of multiple forms. For example, the boom can have both significant tensile and compressive strengths, such as that which might be found for a stiff rod or object. Such booms can enable reaches of up to 20 to 50 meters in various embodiments. Greater distances are also achievable for some applications. Alternatively, a tensile-only boom can take the form of a cable or cord, which can enable very long reaches of greater than 1 km. Such tensile-only booms can have very low stowed volume and mass per unit length. As yet another alternative, a combination tensile/compressive and tensile-only boom can be used, with different portions of the boom having different properties.

Such a combination of tensile only and tensile/compressive booms mentioned can take several forms including, for example, a tether with a short STEM-style shape-memory alloy boom section attached at the EA pad end of the tether. The tether reel can be designed so that once the tether portion reels in far enough, then the STEM-part of the boom can enter the spooling mechanism and start providing compressive strength to the assembly. As another embodiment, a tether with a system at the end that includes its own tensile/compressive sticky-boom device can be used. As yet another embodiment, a tether that feeds out through the middle of a tensile/compressive boom section can be used, such that once the tether is retracted far enough, the EA pad contacts the end of the tensile/compressive boom system, and then the tensile/compressive boom and the tether are reeled in at the same rate.

In the event that a combination tether and tensile/compressive system mentioned is long enough, such a system can enable the contact operations to be performed with the target spacecraft or object outside of a “keep-out” volume for a space station or other host or controlling device. Such a distance can be on the order of 500 meters to one km, or more. By doing this, a spacecraft in a lower orbit, that never actually intersects with the station orbit (and is thus safe) can be grabbed, velocity matched, and then pulled-in to the station without ever having to do independent flight maneuvers that ever bring it within even several hundred meters of the station. Such an arrangement can make it much easier to bring small spacecraft to a given location, like ISS or a propellant depot.

Further, such a combination boom could also be in the form of a micro-tug capable of separating from the tether section. Such an arrangement could also include multiple EA pad sections or connections, for added flexibility in maneuvers and handling of difficult foreign objects, the boom, and the overall system. Under such a multiple EA arrangement, the separate micro-tug could then independently maneuver to a target, capture it using its own sticky-booms, and then haul it back to the tether, reattach to the tether, and the whole system gets reeled back in.

In these examples and various other embodiments, a given spacecraft or controlling device can use multiple sticky-booms, potentially of different configurations, to enable initial capture, velocity matching, pulling the spacecraft or other foreign object in, aligning the foreign object appropriately, and then performing a final berthing option. In addition, various gravity gradient effects can result in some long tether-like booms desirably operating along a line pointing between the station center of gravity and the center of the orbiting body.

In still further application examples, a tether based system can be fired out similar to a grappling hook. The tether boom can then be spooled out at a rate to avoid decelerating the EA pad at the end. Various rendezvous and docking techniques provided herein can be analogous to boat docking in some cases, where mooring lines are tossed from the boat to the pier and used to slowly pull the vessel in, with compressive fenders used to slow the boat down on initial contact. Such embodiments can also be analogous to mid-air refueling, where a low-inertia connection between the two vehicles is advantageously made.

In general, the use of electroadhesion for these applications is attractive in its flexibility, since EA pads can typically be used on a wide range of spacecraft surfaces. This enables the capture of a wide range of spacecraft and other items without the need to engineer custom hardware for each mission. The EA pad also enables a decrease in complexity by gripping spacecraft surfaces with no moving parts, while also providing an inherent ability for non-mechanical proximity and contact detection. Advantages of such systems are numerous, in terms of increased safety, lower propellant usage, lower impact and simpler systems and sensors.

For example, providing connection at a distance via a low-inertia EA pad/boom combination reduces the odds of accidental spacecraft collisions significantly compared to existing rendezvous and docking concepts. Depending on the length of the boom, it may even be feasible in some cases to capture a spacecraft that is in a close but non-intersecting orbit. Also by eliminating the need for close in propulsive maneuvering, spacecraft damage from RCS plume impingement becomes less of an issue. Furthermore, by allowing the last several tens of meters to be closed electromechanically, and due to the large tolerance for relative misalignments, velocity and angular rate mismatches, the amount of propellant needed for spacecraft capture is significantly lower than for existing rendezvous and docking approaches.

In addition, the use of a long boom or tether allows spacecraft momentum mismatches to be equalized over a much longer stroke, greatly reducing the shock loads and microgravity disturbances caused by a docking event, and significantly reducing the required shock absorption weight for a rendezvous and docking system. Still further, the disclosed sticky boom systems enable much simpler rendezvous and docking control due to the wide range of motion of the boom system, the higher tolerance for relative velocity and rotation mismatches, and the ability to steer the boom without the complexities of propulsive orbital dynamics. These systems also require less precise knowledge of relative orbital elements for the two vehicles, enabling the use of cheaper more robust sensors.

Moving next to FIG. 7B, the exemplary sticky boom system of FIG. 7A is similarly illustrated in side perspective view as being coupled to an exemplary controlling craft in outer space according to one embodiment of the present invention.

As shown, controlling craft 180 can include a number of components, including an electroadhesive sticky boom having an EA pad 110, a boom 135 and a boom deployment component 145. Such a sticky boom can be adapted to capture and control various items in space, such as debris or small item 101. Further features on controlling craft 180 can include, for example, a main body 184, one or more solar collectors 186 and a communications component 188, among others.

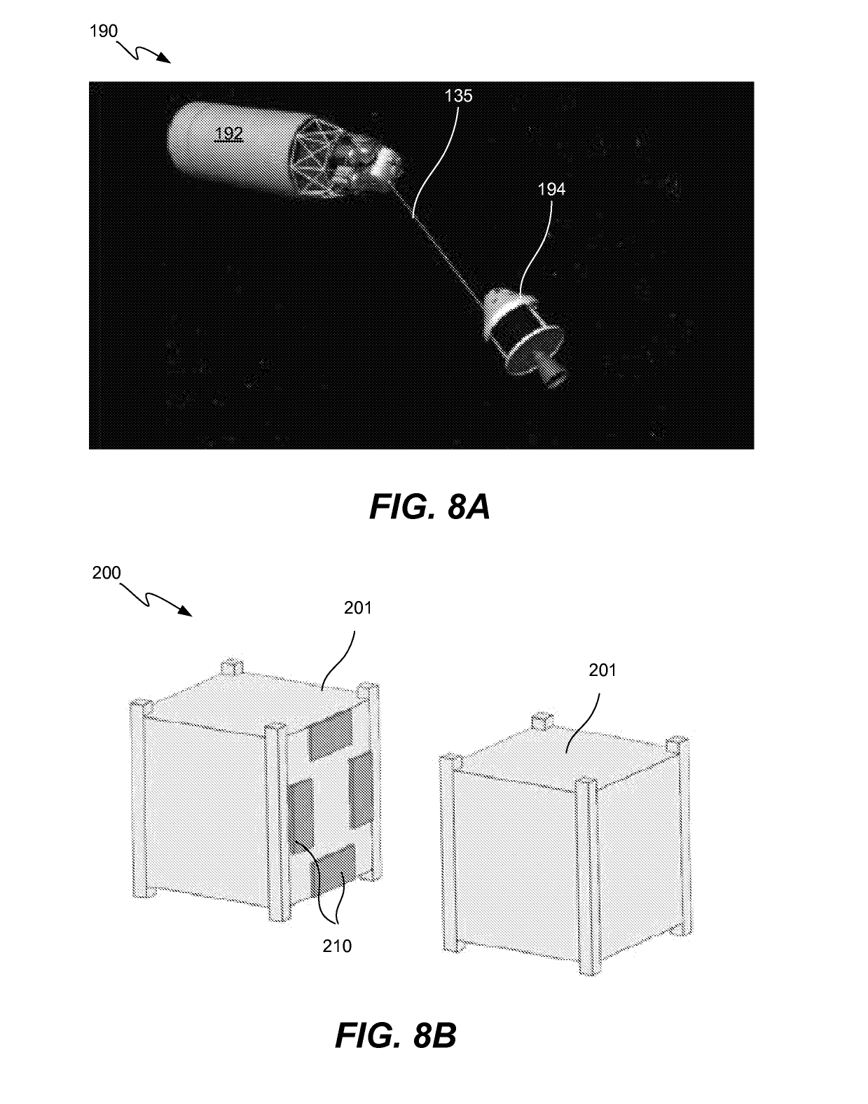

Continuing with FIG. 8A, the exemplary sticky boom system of FIG. 7A is illustrated in side perspective view as being coupled to an alternative exemplary controlling craft and retrieving an exemplary target object in outer space according to another embodiment of the present invention. Controlling craft 190 can include a main body 192 having various controls, power sources and other components (not shown). In addition, boom 135 can extend from controlling craft 190 to contact and control foreign vehicle or object 194, such as for a rendezvous and docking procedure with the controlling craft 190.

One issue that can arise with the use of an electroadhesive sticky boom such as that which is provided above concerns the ability of the EA pad to adhere or “stick” to the target object initially. In practice, it has been observed that such an initial adherence or sticking can be affected by various factors relating to the dynamic interaction between the EA pad and target object. For example, an initial physical contact between the EA pad and target object can result in a collision “bounce” that then separates these items and causes them to drift away from each other before an effective level of electroadhesion can be applied. Since the distance between objects is a critical factor in generating electroadhesive forces, the specific timing of applying charge to the electrodes prior to the bounced objects drifting apart can be important. Alternatively, or in addition, providing systems and techniques that prolong the length of time that the objects are in contact or extremely close proximity can be useful.

With respect to the timing of applying electroadhesive force, one or more sensors can be used to provide feedback as to when the objects are in actual contact or in critical proximity to each other. Such capacitive sensors or the like can help to determine an optimal time window for applying charges to the electrodes for an electroadhesive clamp in various embodiments. In some instances though, a very brief and/or imperfect type of bouncing contact between objects can result in a preference for additional features or techniques to facilitate a good adherence. For example, in some instances where only an edge or corner of an EA pad contacts the target object before a bouncing away occurs, then even a well timed application of electrostatic force may be insufficient.

As such, the use of features such as stiffenable joints or components, electroadhesive skins, or both can be helpful in providing a mode of initial physical contact or interaction that then facilitates a better adhesion when the EA pad is actuated. Such stiffenable joints or other components can involve, for example, an electrostatic clutch, joint brakes and/or locking structures that allow one or more portions of the EA pad and/or boom to transition from a soft or flexible state to a rigid state once a preferred location and/or orientation of the stiffenable item is realized. For example, where an EA pad is being manipulated about a jointed coupling to the end of a boom, such a jointed coupling can preferably be actuated to become stiff or rigid once an optimized orientation of the EA pad with respect to the target object is achieved. As another example, a segmented boom can have stiffenable joints that can then “freeze” a given end segment or other segments in a particular orientation when such an orientation is helpful.

Another feature that can be used to achieve a better initial adherable contact interaction between EA pads and target objects can involve the use of “electroadhesive skins ” Such electroadhesive skins can be in the form of, for example, thin and flexible electroadhesive sheets that readily deform when contacting another object. Rather than experiencing a relatively hard bounce and drift apart when an EA pad contacts a foreign object then, such an EA pad in the form of an EA skin could more readily crumple, graze or otherwise deform in a manner that maintains contact with the foreign object. Such components can thus be used to crumple up against and/or graze gently along the surface of a foreign object in space, so as to maximize the amount of surface area between objects that is actually in contact or near contact. When used in combination, one or more stiffenable joints or components can then be used to freeze or lock the EA pad and/or boom in place once an EA skin has deformed or grazed along the foreign object into an orientation that is good for facilitating electroadhesion.

It will be readily appreciated that numerous other applications involving the various concepts relating to electroadhesion can also be used in similar outer space environments and applications. For example, the scope of spacecraft missions in general and CubeSat-based missions in particular could be dramatically increased by using electroadhesion capabilities to dock two or more CubeSat modules, or to reconfigure two or three unit satellites after deployment from a P-POD (Poly Picosat Orbital Deployer). Mechanical docking systems are complex to design and pose a significant technical risk to a mission, whereas electroadhesive applications provide simpler yet reliable alternatives where designed properly.

FIG. 8B illustrates in side perspective view a pair of CubeSat modules having electroadhesive components adapted to facilitate docking according to one embodiment of the present invention. As shown, CubeSat system 200 can include a plurality of separate modules 201 adapted for docking or otherwise interacting with each other. Each such module 201 can include one or more electroadhesive pads or components 210 located thereon, with such components being arranged to dock or interact with other CubeSat modules.

In keeping with the CubeSat paradigm, an electroadhesive based docking system is simple to design, inexpensive, and rugged, consisting of a few short wires, electrostatic pads, and a small power supply. Such a docking subsystem could have a far reaching impact on CubeSat mission utility. The ability to reconfigure multi-unit satellites could enhance antenna aperture, simplify repeated separation and reconnection of tethered pairs, and could enable a variety of experiments. A simple docking capability would be an enabling technology for multiple cooperative small spacecraft operations, including the use of small auxiliary spacecraft to inspect, maintain, or defend large, high-value satellites. Such a system would allow an auxiliary craft to wait in ready mode docked on its host, then deploy when needed and re-dock after performing its mission. Other possibilities include constellations of CubeSats that occasionally dock to enable a special function or to share resources.

### Methods

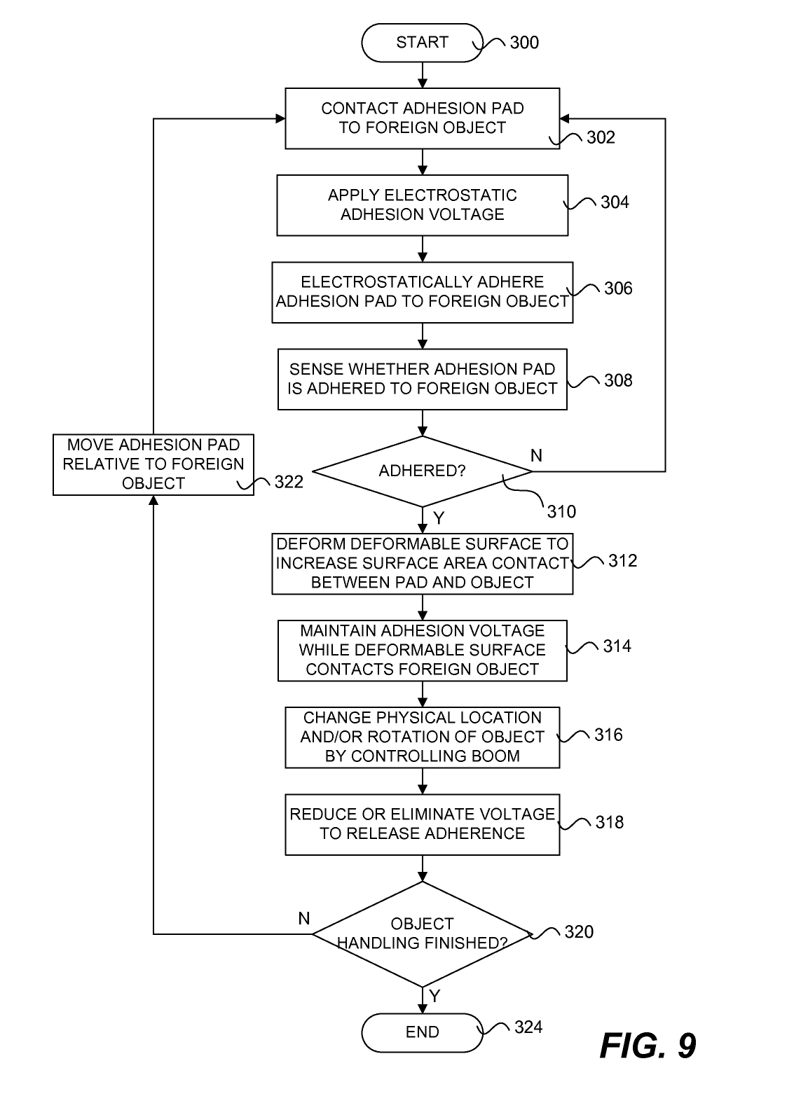

Although a wide variety of applications involving providing manipulating objects using electroadhesion can be imagined, one basic method is provided here as an example. Turning lastly to FIG. 9, a flowchart of an exemplary method of physically controlling a foreign object is provided. In particular, such a method involves operating an electroadhesive system such as a sticky boom. It will be readily appreciated that not every method step set forth in this flowchart is always necessary, and that further steps not set forth herein may also be included. For example, neither the use of a sensor to detect adhesion nor the provision of a deformable surface is necessary in all embodiments. Furthermore, the exact order of steps may be altered as desired for various applications.

Beginning with a start step 300, an electroadhesion pad is contacted to a surface of a foreign vehicle or object at process step 302. An electrostatic adhesion voltage is then applied at process step 304, after which the foreign vehicle or object is adhered to the electroadhesion pad at process step 306. At a following process step 308, the system can then optionally sense whether or not the EA pad is actually adhered to the foreign vehicle or object.

If no actual adherence has been made, then the process reverts to step 302 and repeats until an actual adherence is made. When an adherence is made, then the process continues to step 312, where a deformable surface of then deformed to increase the surface area contact between the EA pad and the foreign object. Such a deformable surface can be the contact surface of the EA pad, for example. At a subsequent process the 314, the adhesion voltage is maintained while the deformable surface contacts the foreign object. As will be readily appreciated, a direct contact between the foreign surface and foreign object is not always necessary, since a thin insulator or other protective layer can be between the surfaces in some cases.

The method then continues to process step 316, where the physical location and/or rotational velocity of the foreign object is then changed by way of the boom and EA pad arrangement while adherence is maintained. After this is done, the electrostatic adhesion voltage is then reduced or eliminated at process step 318, after which an inquiry is made at decision step 320 as to whether the handling of the vehicle or other foreign object is finished. If not, then the method continues to process step 322, whereupon the electroadhesion pad is moved relative to the foreign object to a new location at its surface. The method then reverts to step 302 and repeats for all steps at the new location of contact for the EA pad.

In the event that object handling is finished at 320, however, then the method proceeds to finish at and end step 324. Further steps not depicted can include, for example, coupling the boom to the electroadhesive pad, or manipulating a plurality of electroadhesive pads rather than just one. Other steps can include providing feedback from one or more sensors to a controller to result in adjusted movements of the boom, for example, and any or all of the steps may be repeated any number of times, as may be desired.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

1. An electroadhesive system for manipulating an object in a zero-gravity environment, the system comprising:
an electrostatic adhesion pad configured to adhere electrostatically and detachably to a surface of the object within the zero-gravity environment, wherein said electrostatic adhesion pad includes one or more electrodes adapted to produce collectively an electrostatic force between the pad and the object that is suitable to maintain a current position of the pad relative to the object; and
an end effector adapted to be coupled to a boom at a first boom location to provide control for positioning of the pad with respect to the object and also for movement of the pad and object combination when the pad and object are electrostatically adhered together.

2. The electroadhesive system of claim 1, wherein said electrostatic adhesion pad includes a deformable surface adapted for interfacing with a surface of the object, and wherein at least a portion of said deformable surface moves closer to the object surface when the pad is adhering to the object.

3. The electroadhesive system of claim 1, wherein at least a portion of the electrostatic adhesion pad, the end effector or both are adapted to be stiffened after the electrostatic adhesion pad initially contacts the object.

4. The electroadhesive system of claim 1, further including:
a sensing component adapted to sense when said electrostatic adhesion pad is electrostatically adhered to the object.

5. (canceled)

6. The electroadhesive system of claim 1, wherein said electrostatic adhesion pad comprises a flat or flexible component.

7. The electroadhesive system of claim 1, wherein said electrostatic adhesion pad comprises a plurality of separately controllable fingers.

8. The electroadhesive system of claim 1, wherein said electrostatic adhesion pad is further configured to adhere electrostatically and detachably to a surface of a second object while the pad is simultaneously adhered to the original object.

9. (canceled)

10. (canceled)

11. The electroadhesive system of claim 1, wherein said electroadhesive system is adapted to manipulate the physical location of the object, the rotational velocity of the object, or both.

12. A method for physically controlling an object in a zero-gravity environment, comprising:
contacting an electrostatic adhesion pad to a surface of the object within the zero-gravity environment, wherein said electrostatic adhesion pad includes one or more electrodes;
applying an electrostatic adhesion voltage difference to at least one of said one or more electrodes; and
electrostatically adhering said electrostatic adhesion pad to a surface of the object using an electrostatic attraction force provided by the electrostatic adhesion voltage difference,
whereby changing the physical location of the foreign object, the rotational velocity of the foreign object, or both can be changed by controlling an end effector coupled to a boom coupled to said electrostatic adhesion pad while the pad and object are electrostatically adhered together.

13. The method of claim 12, further comprising:
after electrostatically adhering said electrostatic adhesion pad to the object surface, increasing the surface area contact between the pad and the object surface by deforming a deformable surface on the electrostatic adhesion pad such that at least a portion of the deformable pad surface moves closer to the object surface; and
maintaining the electrostatic adhesion voltage difference while the deformable pad surface contacts the object surface.

14. (canceled)

15. The method of claim 12, further comprising:
releasing the electrostatic adherence between the pad and the object by reducing or eliminating said electrostatic adhesion voltage difference.

16. The method of claim 15, further comprising:
moving said electrostatic adhesion pad with respect to the object while the electrostatic adhesion voltage is reduced or eliminated; and
reapplying an electrostatic adhesion voltage difference at at least one of said one or more electrodes after said electrostatic adhesion pad has been moved to a different location of the object.

17. The method of claim 12, further comprising:
sensing when said electrostatic adhesion pad is electrostatically adhered to the object.
controlling said boom in response to sensing that the pad is electrostatically adhered to the foreign object.

18. (canceled)

19. (canceled)

20. The method of claim 12, further comprising:
stiffening at least a portion of the electrostatic adhesion pad, end effector or both after said step of contacting.
